(19) United States
(12) Patent Application Publication
(10) Pub. No.: US 2012/0110891 A1
(43) Pub. Date: May 10, 2012

(54) PLANT PEST TRAP AND METHODOLOGY OF USE

(76) Inventor: Kip W. Minnameier, Reno, NV (US)

(21) Appl. No.: 13/291,085

(22) Filed: Nov. 7, 2011

Related U.S. Application Data
(60) Provisional application No. 61/410,352, filed on Nov. 5, 2010.

(51) Int. Cl. A01M 99/00

(52) U.S. Cl. 43/58

(57) ABSTRACT

The invention could be a plant pest trap and a method of using same, the trap comprising of a laminate of a first sheet and a cover, the first sheet having a thickness greater than the cover, the first sheet further comprising of a first side and second side, the first side bearing a low adhesion adhesive and a bright color, while the second side presents a graphic representation, the cover reversibly covers the first side of the second sheet, the laminate being formed into a shape that matches the outline of the representation presented by the second side; a support staff secures at one end to the laminate while the other end of the support staff is used to anchors the staff in soil surrounding a plant to which the trap is to protect after the protective covering is removed from the first sheet.

### CROSS-REFERENCES TO RELATED APPLICATIONS

This application claims the benefit under 35 U.S.C. §119(e) of U.S. Provisional Patent Application No. 61410352, filed on Nov. 05, 2011, contents of which are relied upon and incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to traps generally used to catch small pests, such as bugs and insects. More particularity to those traps that are generally used to catch pests that are attracted to plants.

### BACKGROUND

Annoying to many plant growers is the almost inevitable following of bugs, insects, and other small pests that are attracted to and maintain a close proximity to plants. These plant pests can include fruit flies, white flies, mealy bugs, mites, thrips, fungus gnats, and the like that are known to infest plants and their supporting soils. These pests, especially the flying variety, in addition to causing actual damage to the plant and spreading their infestation to other plants in the vicinity, may also be a general annoyance that causes a distraction from the enjoyment of the plants.

Various solutions to such plant pest infestations may include washing the plant periodically with a vigorous jet of water; initiating soil/site/climate changes (changing watering of the planting, placing it in a different temperature area, etc.); handpicking off larger plant pests; quarantining the infested plant (e.g., isolating or throwing out infested plants for the welfare of other houseplants); trapping and the like. Trapping can be accomplished in a wide variety of manner such as using commercial traps having a wide variety of construction and usage. One such trap could be a container whose interior may have a liquid that attracts and drowns the pests within the interior of the container. Another trap could be a container that dispenses a roll of tape having at least one sticky side (e.g., fly paper), the tape being exposed to pests by being hung down from a surface proximate to the afflicted plant. The pests could be attracted and become affixed to the sticky side by a variety of attractants. Yet another trap could be a commercially available or home-made made from paper card sheet or the like. At least one side of the paper could be sticky to attract the pests, allowing the pests land upon and become stuck to the sticky side of sheet. The other side of paper could then be laid down prone (or hung vertically down from a structure) near the plants to be allow the trap to become effective.

The deployment of traps may have some limitations in that their presence may generally detract from the enjoyment of the plants (both indoor and outdoor plants) by plant fanciers and others. This may be particularly true of plant pest trap deployment with flowering plants (arranged in many cases to be a showcase) wherein the trap's bulk may be distracting from or the trap mechanism may need to intrude upon the floral portion to effectively trap the plant pests present.

What is needed therefore is a plant pest trap whose structure, size, form, and overall presentation allows it to be deployed in a non-intrusive and possibly complementary manner when in close proximately to the plant that it is intended to protect. Such a trap could further have a support mechanism allows for a wide variety of different trap placements relative to the plant that also allow the trap to further complement and enhance the overall presentation of the plant.

### SUMMARY OF ONE EMBODIMENT OF THE INVENTION

### Advantages of One or More Embodiments of the Present Invention

The various embodiments of the present invention may, but do not necessarily, achieve one or more of the following advantages:

to provide a planar laminate plant pest trap, with a removable backing that exposes a sticky side to trap plant pests and a reverse side that features a pleasing design that could be complementary to the plant that the trap is placed in close proximity;

to provide a laminate plant pest trap that is proportionally sized so that its presence proximate to the plant it protects does not detract from the presentation and enjoyment of the plant;

the ability to trap plant pests with means that can be supported unobtrusively in the soil proximate to the plant it is intended to protect;

to provide a plant trap that has the general form and look of objects that complement the presentation of the plant to which the trap has been placed proximate;

the ability to accessorize a presentation of a plant with plant pest traps having pleasing sizes, shapes, and graphics; and

to provide a means to trap plant pests that does not infer with or detract from the presentation of the plant when that the means is placed proximate to the plant.

These and other advantages may be realized by reference to the remaining portions of the specification, claims, and abstract.

### Brief Description of One Embodiment of the Present Invention

One possible embodiment could be a plant pest trap comprising of a laminate a first sheet and cover, the first sheet having a thickness greater than the cover, the first sheet having a first side and a second side, the first side bearing a low adhesion adhesive coat and the second side presenting a graphic representation, the cover being a removably applied to the first side, the laminate being formed into a shape that matches the outline of the graphic presented by the second side; a support staff at one end attached to at least a portion of the laminate while the other end anchors the support staff in soil proximate to one or more plants to which the plant pest trap is intended to protect.

Another possible embodiment is a method for using a plant pest trap comprising of the following steps, providing a plant pest trap comprising of a laminate of at least two sheets and a support staff, the first sheet further bearing an low adhesion adhesive coating on a first side and graphic on a second side, the second sheet being a removable cover reversibly applied to the first side; providing one or more plants supported by soil; removing the second sheet from the first side; attaching the first sheet to the support staff; and anchoring the support staff in the soil to hold the first sheet upright and distal form the soil proximate to the one or more plants that the plant pest trap is intended to protect.

The above-description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a front perspective view of one embodiment of present invention.

FIG. 2 is substantially a back perspective view of one embodiment of the present invention.

FIG. 3 is substantially a kit form of the invention.

FIG. 4 is substantially a flow chart for the methodology embodiment of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

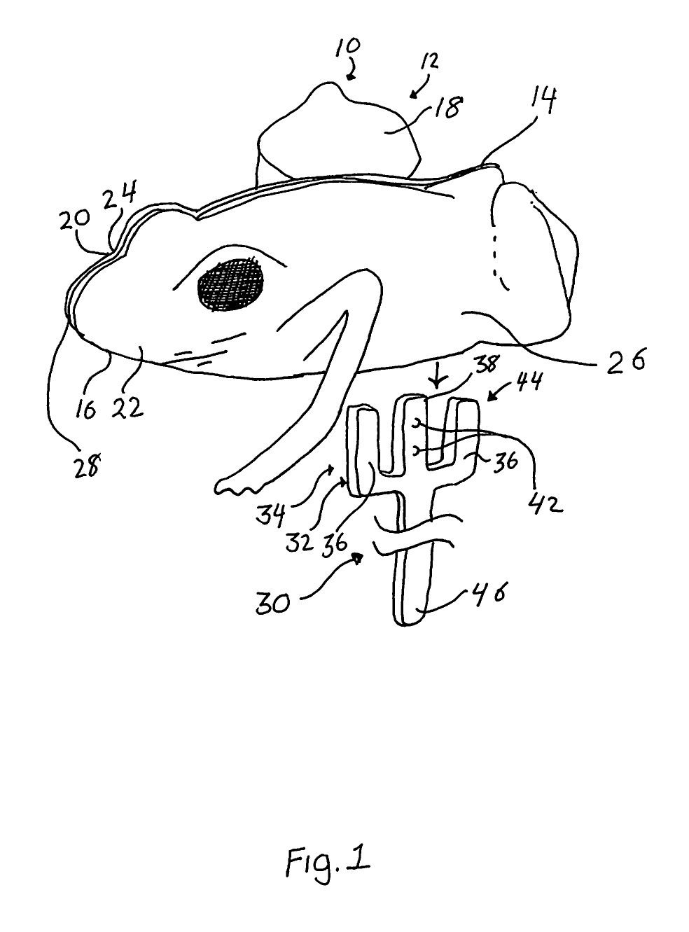

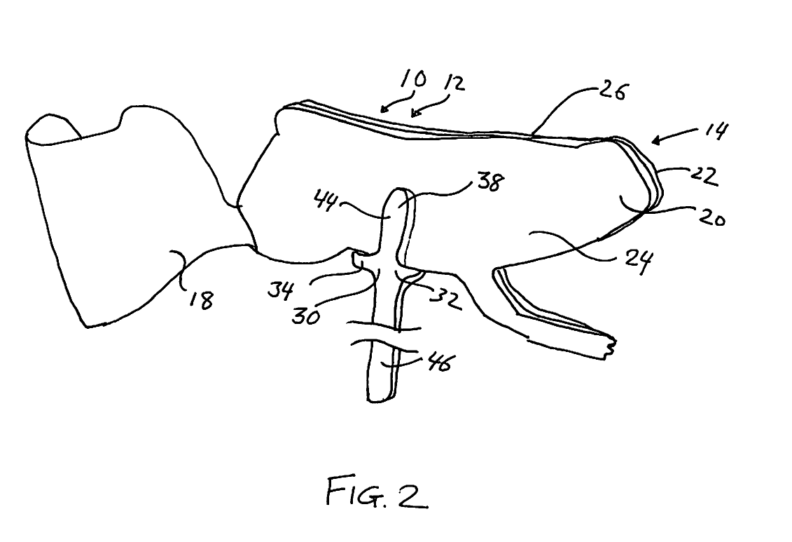

The present invention 10 could comprise of plant pest trap 12 and a methodology for its use 100. As substantially shown in FIGS. 1 and 2, the plant pest trap 12 could be used indoors or outdoors and is a combination of a laminate 14 and at least one support staff 30. The laminate 14 comprises of at least two sheets, a first sheet 14 and a thinner second sheet 16. The first sheet 14 could be made from a heavy card stock and feature a first side 20 and second side 22. The first side 20 could present and expose a low-adhesion adhesive coat 24, such as HL 2405 from HB Fuller, 1200 Willow Lake Boulevard, P.O. Box 64683, St. Paul, Minn. 55164-0683, 651-236-5900. This low-adhesion adhesive coat 24 could further be mixed with or otherwise impregnated with a sweet scent (such a mint oil or honey) that could further emit an odor that could attract plant pests to the adhesive coat 24. The first side 20 could be light in color to further aid in the attraction of plant pests to the adhesive coat 24 (e.g., colors of yellow and blue and combinations there of appear generally to be effective at attracting various plant pests.) The second side 22 could feature a graphic 26 that can compliment the presentation of the plant(s) to which the invention 10 will be located proximate.

This graphic 26 could be a photographic or other representation of an animal or a plant; a pure design graphic such as a heart, stars, and the like. The graphic could present its representation as an object whose one-to-one scale is it smaller than the plant to which it will be proximate. In another instance, the graphic 26 could be of a camouflage that substantially mimics patterns of foliage, to generally allow the trap 12 to less noticeable and blend inconspicuously with one or more plants to which it could be placed proximate to protect. In at least one embodiment, the graphic 26 could further present its image in a perspective or three-dimensional view.

In one possible embodiment of the invention 10, a set of these laminates 14 could be made by printing on the first sheet 14 a plurality of one or more different graphics 26 printed onto its second side 22. The first side 20 of the first sheet 14 could be constructed to display one or more suitable pest attracting bright colors. After the graphics 26 have been applied, the suitable low-adhesion adhesive (that may further incorporate an appropriate plant pest attracting scent) could applied by suitable method (e.g., spray, roller, or brush, etc.) to form the adhesive coating 24 on the first side 20. The second sheet 22 (e.g., a removable cover or releasable liner) could have a waxy or low-stick texture that could allow the second sheet 22 to be reversibly applied to the first side 20 to reversibly cover the adhesive coat 24. The completed sheet of laminate 14 could then be taken to a die cutter where it could be laser cut into several forms whose outlines match up to the outlines of the graphics 26 on the second side 22. Upon activation of the trap 12, wherein the second sheet or removable cover sheet 22 is removed from the initial laminate 14 to expose the adhesive coat 24 of the first side 20 and form a remaining laminate 28, which is then generally ready to be attached to and be supported by the support staff 30. The support staff 30 could be anchored in soil proximate to the plants to be protected, the support staff holding the remaining laminate 28 upright and distal from the soil.

To facilitate this attachment of the laminate to the support staff 30, the support staff 30 in at least one embodiment, could have at its first end 44 an attachment means 34 to attach at least a portion of the laminate 14 (e.g., the remaining laminate 28) to the support staff 30. The attachment means 34 could be a trident or fork 32 comprised a set of three commonly connected prongs formed by having a middle prong 38 located between two outside prongs 36, the middle prong 38 being generally placed off-center and away from the shared plane of the two outside prongs 38. The area between the middle prong 38 and the outside prong pair 36 could generally denote a receiving area 40 wherein a portion of the laminate 14 (e.g., remaining laminate 28) could be inserted to attach itself to an end of the support staff 30. The middle prong 38 could further have a rough surface (e.g., one or more dimples 42) to facilitate holding the laminate 14 in place within the receiving area 40. The adhesive coat 24 further acting to hold the remaining laminate 28 within the receiving area 40. The second end 46 of the support staff 30 can be planted in the soil supporting the plant(s) to which the invention 10 is being placed proximate to protect from plant pests.

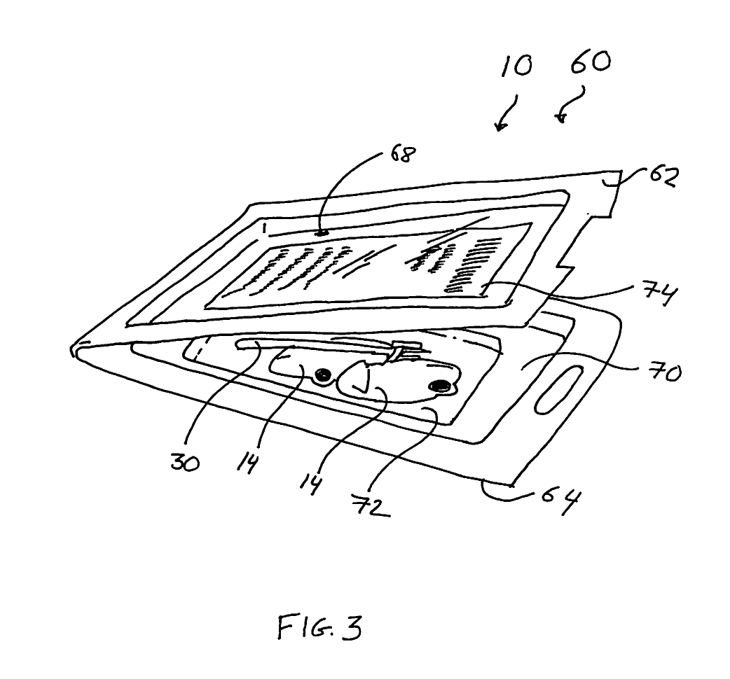

As substantially shown in FIG. 3, at least one embodiment of the invention 10 could be a kit 60 containing one or more laminates 14 and one or more support staffs 30. In one possible embodiment, the graphic representation of each of the one or more laminates could be different from one another.

The kit 60 could be a clear, plastic box container 62 having a front cover 64 flexibly connected at one end to a corresponding back cover 66. The back cover 66 could have a convex box-like portion 68 that can protrude into a corresponding concave box-like portion 70 of the front cover 64 when the two covers are placed on top of one another. The friction fit of the convex portion 68 into the concave portion 70 could hold the front cover 64 proximate to the back cover 66 to generally form the enclosed box container 62 for the kit 60. An additional depression 72 in the front cover 64 could further form a receptacle to hold the laminates 14 and support staffs 30. The kit 60 could further feature cardstock inserts 72 (held between the two covers 62, 64) with suitable designs and indicia advertising the invention 10 and providing instructions for its use.

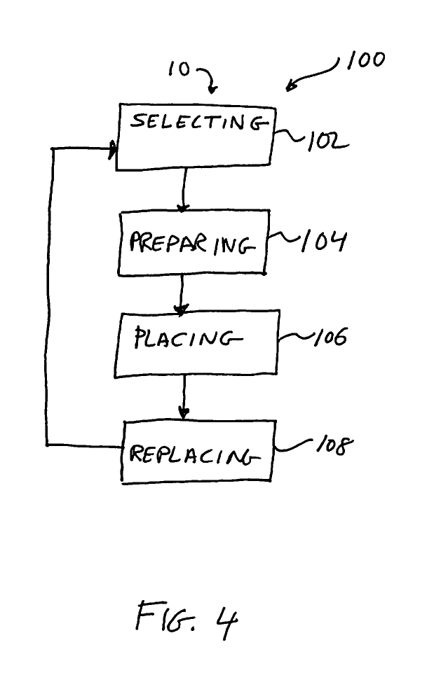

As substantially shown in FIG. 4, one possible process or methodology 100 for operating the invention 10 could start step 102, selecting the invention 10 based on its graphic/shape/size and other pertinent criteria. The operator could select different examples of the invention based on which graphic (and its corresponding size and outline shape) provided by a particular laminate could best complement, in the opinion of the operator, the overall presentation of the plant(s) to which the invention 10 would be associated. After step 102 is substantially completed, the process 100 could proceed to step 104, preparing of the laminate.

In step 104, the operator could remove the selected laminate and a support staff from an invention kit, if the invention is supplied in such a manner. The operator, in one embodiment could remove the second sheet or cover to expose the adhesive coating (creating the remaining laminate) and then affix the remaining laminate upon the attachment means (insert remaining laminate into the receiving area). The operator could, in another embodiment, first place the laminate onto the support staff and then remove the cover sheet.

Once the remaining laminate and support staff have been substantially assembled together, the process 100 could proceed onto step 106, placing the invention proximate to the plant(s).

In step 106, the operator could locate the assembled invention in the soil surrounding the plant(s). The plant(s) could be planted in soil in a container located indoors or in soil located outdoors. The placement of the assembled invention being balanced by factors such as the effectiveness to attract plant pests, complementing the plant presentation; and other criteria left to the personal taste of the operator. The operator could grasp the invention by its staff, and insert the send end of the support staff into the soil proximate to the one or more plants that the operator wants to protect with invention. The support staff is anchored in the soil to place the remaining laminate in an upright position that is distal from the soil. After the substantial completion of this step 106, the process 100 could proceed to step 108, replacing the trap.

In step 108, the operator could check the first side to see if it has attracted and hence has caught plant pests. The bright color could highlight for the operator those pests stuck on the first side. If a significant portion of the first side is covered with plant pests (or if used in conjunction with outside plants also covered with dust, dirt and alike, thereby impending the effectiveness of the trap), the operator can remove the assembled invention/pests from the plant/soil and dispose of it in a responsible manner. The process 100 could then proceed back to step 102 for placing a new assembled invention in proximity to the desired plant if pest problem is still noticeable.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

As seen by the above description, the invention may provide for a planar laminate plant pest trap that can be anchored in soil of household plant proximate to the plant itself. The invention has an easily removed backing that exposes a side of the trap having a low adhesion adhesive layer further providing a scent a coloring to attract and trap the plant pests. The trap's other side presenting a pleasing graphic, along with the outline shape and overall size of the trap can complement, and not detract from, the presentation of the plant.

What is claimed is:

1. A plant pest trap comprising:
(A) a laminate of at least two sheets, a first sheet having a thickness greater than a second sheet, the first sheet further being comprised of a first side and second side, the first side bearing a low adhesion adhesive coat, while the second side presents a graphic representation, the second sheet being removably applied to the first side of the second sheet;
(B) a support staff having a first end and a second end, the first end having an attachment means for securing a portion of the laminate to the support staff, the second end is used to anchor the support staff in a soil proximate at least one plant to which the trap is intended to protect;
wherein the reversible cover is removed to form a remaining laminate that is attached to the attachment means of the support staff.

2. The plant pest trap of claim 1 wherein the laminate is cut to follow the outline of the graphic representation. The plant pest trap of claim 1 wherein the attachment means is a three-prong fork. The plant pest trap of claim 3 wherein the adhesive coat further acts retains a portion of the remaining laminate within the attachment means. The plant pest trap of claim 1 wherein the graphic representation is a camouflage that allows the trap to blend in with the plant surroundings and be placed inconspicuously proximate to the one or more plants that the trap is to protect. The plant pest trap of claim 1 wherein the laminate size and shape along with the graphic representation provide a plant pest trap this is visually pleasing and complementary to the one or more plants to which the trap is placed proximate. The plant pest trap of claim 1 wherein the first side is brightly-colored. The plant pest trap of claim 1 wherein the adhesive coating further gives off a scent that is attractive to plant pests, the scent being provided by honey or mint oil mixed in with the adhesive. The plant pest trap of claim 1 wherein the staff is anchored in the soil to hold the remaining laminate upright and distal from the soil. The plant pest trap of claim 1 wherein the plant is located outdoors. The plant pest trap of claim 1 wherein the adhesive of the low adhesion adhesive coat is HL 2405.

3. A method for using a plant pest trap comprising of the following steps, but not necessarily in the order shown: providing a plant pest trap comprising of a laminate of at least two sheets, the first sheet further comprising of a first side and second side, the first side bearing a low adhesion adhesive coat and the second side presenting a graphic representation, the second sheet being a removable cover applied to the first side of the second sheet, the entire laminate being cut to match the outline of the graphic representation, and a support staff having a first end with an attachment means for securing at least a portion of the laminate to the support staff, the other second end being used to anchor the staff in a soil supporting one or more plants to which the trap is intended to protect;
(B) providing at least one or more plants supported by soil;
(C) removing the second sheet from the second side to form a remaining laminate;
(D) attaching the remaining laminate to the attachment means; and
(E) anchoring the support staff in the soil surrounding the one or more plants the plant pest trap is intended to protect.

4. The method of claim 12 wherein anchoring the support staff further comprising a step of holding the remaining laminate upright and distal from the soil.

5. The method of claim 12 further comprising of a step of attracting pests to the adhesive coat by emitting a scent from the low adhesion adhesive coat.

6. The method of claim 14 wherein the step of attracting plant pests to the adhesive coat is done is accomplished by having the first side brightly colored.

7. The method of claim 12 further comprising of a step of selecting the laminate whose shape, size, and graphic representation allow it to inconspicuously blend in with the one or more plants to which the plant pest trap is placed proximate.

8. The method of claim 12 further comprising of a step of selecting the laminate whose shape, size, and graphic representation allows it to be visually pleasing and complementary to the one or more plants to which the plant pest trap is placed proximate.

9. The method of claim 12 wherein attaching the remaining laminate to the attachment means further comprises a step of retaining the remaining laminate to the attachment means by using the low adhesion adhesive coat to adhere to the fork of the attachment means.

10. A kit for a plant pest trap comprising of:
(A) one or more laminates, each laminate having a first sheet and a cover, the first sheet having a the first side bearing a low adhesion adhesive coat reversibly covered by the cover and the second side presenting a graphic representation, the laminate being cut to match the outline of the graphic representation; the cover being removed to form a remaining laminate;
(B) one or more support staffs, one end of the staff is to be inserted into the soil proximate the one or more plants that are to be protected by the trap, the other end presenting an attachment means for attaching the remaining laminate to the support staff; and
(C) a box container having a front cover flexibly and hingedly connected by a common end to a corresponding back cover,
wherein the back cover has a convex box-like portion that can protrude into a corresponding reciprocal concave box-like portion of the front cover when the two covers are closed together to form an enclosed receptacle holding the one or more laminates; one or more support staffs; and one or more inserts with suitable designs and indicia advertising the plant pest trap and providing instructions for its use.

11. The kit of claim 19 wherein the graphic representation of each of the one or more laminates is different from one another.
